(19) United States
(12) Patent Application Publication
(10) Pub. No.: US 2011/0281589 A1
(43) Pub. Date: Nov. 17, 2011

(54) SMS ROUTING

(76) Inventor: Leon DE BEER, Newbury (GB)

(21) Appl. No.: 13/190,196

(22) Filed: Jul. 25, 2011

Related U.S. Application Data
(63) Continuation of application No. 12/119,286, filed on May 12, 2008, now abandoned.
Application No. 12/119,286 is a continuation of application No. 11/860,100, filed on Sep. 24, 2007, now abandoned.
Application No. 11/860,100 is a continuation of application No. 11/698,990, filed on Jan. 29, 2007, now abandoned.
Application No. 11/698,990 is a continuation of application No. 11/446,528, filed on Jun. 5, 2006, now abandoned.
Application No. 11/446,528 is a continuation of application No. 11/245,165, filed on Oct. 7, 2005, now abandoned.
Application No. 11/245,165 is a continuation of application No. 11/040,110, filed on Jan. 24, 2005, now abandoned.
Application No. 11/040,110 is a continuation of application No. 10/482,163, now abandoned.

(30) Foreign Application Priority Data
Jul. 6, 2001 (GB) 0116592.7

(51) Int. Cl. H04W 40/00

(52) U.S. Cl. 455/445

(57) ABSTRACT

Mobile terminals are operated in a mobile telecommunications system such as GSM routing data messages such as SMS messages to a destination address via a selected of plural routing centers. A terminal receives user generated data defining an outgoing message and generates a first data field containing a first routing center address, a second data field containing the destination address, and a third data field containing the user generated data. The terminal traps the outgoing message and compares the first routing center address and a second routing center address, determined by a system administrator, stored in a memory the user cannot write-access. If the addresses differ, the first routing center address is replaced by the second routing center address in the data field and the outgoing message is routed via a second routing center with the second routing center address. The administrator thereby controls message routing.

### CROSS-REFERENCE PARAGRAPH

This application is a Continuation application of Ser. No. 12/119,286 filed May 12, 2008, which is a Continuation of Ser. No. 11/860,100 filed Sep. 24, 2007, which is a Continuation of Ser. No. 11/698,990 filed Jan. 29, 2007, which is a Continuation of Ser. No. 11/446,528 filed Jun. 5, 2006, which is a Continuation of Ser. No. 11/245,165 filed Oct. 7, 2005, which is a Continuation of Ser. No. 11/040,110 filed Jan. 24, 2005, which is a Continuation of Ser. No. 10/482,163 filed Jan. 6, 2004, which is the National Stage of PCT/GB02/03036, filed Jul. 2, 2002, and claims priority to Great Britain Patent No. 0116592.7, filed Jul. 6, 2001, the entire contents of both of these applications being incorporated herein by reference.

### BACKGROUND OF THE INVENTION

This invention relates to the routing of messages within a telecommunications system and in particular but not exclusively to mobile terminals such as mobile telephones capable of sending text messages in the SMS format within a GSM system. The invention also has application to WAP enabled mobile telephones and the routing of messages via selected gateways to the internet.

The GSM (Global System for Mobile Communications) standard for telecommunications has been widely adopted in many countries and continues to evolve with more sophisticated services. The SMS (Short Message Service) allows mobile terminals such as mobile telephones to send and receive text messages, SMS having been created as part of the GSM phase 1 standard. Each short message comprises up to 160 characters. The sending of such text messages has become increasingly popular as a generally low cost alternative to voice mail messages and they provide a simple and easily accessed alternative to email.

A mobile terminal generating an outgoing SMS message prepares the message in packet form in which the message content is accompanied by a header which includes a number of fields including address information. The address information includes riot only the address of the intended call destination but the address of an SMSC (Short Message Service Center) via which the message packet is to be routed. The SMSC performs a store-and-forward function to route the message packet onwards to the call destination terminal at a time when it is able to receive it. The SMSC also extracts information for administration and billing purposes and passes this information to the appropriate network entity.

The GSM system is a cellular mobile system in which a number of different network operators provide cellular networks in communication with other like networks and with land line networks. Operators of different networks compete with different tariffs and levels of service and the GSM system caters for user selection of network services in a variety of ways.

Typically the mobile terminal contains a SIM (Subscriber Identity Module) in the form of a smart card containing in its memory a unique identifier and subscriber information which identifies the mobile terminal with a home network controlled by a home network operator with whom a subscriber has a contractual relationship for allowing use of the mobile terminal within the GSM system. The SIM card now has a multitude of functions and is capable of interacting with the processor of the mobile terminal in a manner which is standardized to allow interchangeability of SIM cards with different mobile terminal equipment. The European Telecommunications Standards Institute (ETSI) technical specification TS101267 defines a standard for the interface between SIM card and mobile equipment, referring to a SIM Application Toolkit. For example, the Application Toolkit utilizes an “Envelope” command for the transparent transfer of data between the mobile terminal processor and the SIM card, for example when the data is received in an SMS message either by point to point or cell broadcast with CB, thereby enabling data in the SIM card to be updated on receipt of broadcast information. A further facility which can be activated by the SIM card is that of “Mobile Originated Short Message control by the SIM”. When activated, the mobile equipment processor passes address information for short messages to the SIM card before the mobile equipment processor sends the short message for transmission. The SIM card may then allow or disallow the sending of the SMS message and may modify the sending address of the short message.

Further details of the interface between mobile equipment processor and SIM card are described in the ETSI technical specification ETSI TS100799.

This ETSI technical specification refers to Elementary Files stored in the SIM card and defines a naming scheme for elementary files for different purposes.

The home network for the mobile terminal subscriber is responsible for collecting billing information for telecommunications services including voice and SMS services and obtaining payment from the subscriber. An increasingly popular option is for mobile telephone use to be on the basis of a pre-paid subscription in which vouchers or credits are purchased in advance by a user, rather than the accumulated cost of services being billed after use.

It is common practice for the home network operator to provide as part of its mobile network infrastructure the SMSC used by its own subscribers when they use the mobile terminal to send SMS messages to a call destination. This makes coordinated billing and administration for different services a simple task and in particular presents no bar to the use of prepaid subscriber services in which the subscriber acquires credits in advance for use of network services. It is also possible for a home network operator to make use of an independently operated SMSC, for example, if its own facilities are unable to cope with the volume of SMS traffic or if the independent SMSC is able to provide enhanced services.

It is a feature of the GSM system that a mobile terminal is able to generate outgoing SMS messages containing an SMSC address belonging to an SMSC which is selected by the user of the mobile terminal. This arises because mobile terminals such as mobile telephones store the address of the SMSC in the memory of the SIM card in a file which is commonly preconfigured with the preferred SMSC address of the home network but can be accessed and updated by the user. The user may for example be able to enter a new address via a keypad of the mobile terminal or by selection from a menu.

The motivation for using a different SMSC from the point of view of the subscriber is that competing network operators charge different prices for handling SMS messages so that a subscriber could benefit from accessing a less expensive SMSC controlled by a network operator other than the home network.

When a message packet is routed by an SMSC which is other than the home network's own SMSC, the SMSC will in general generate billing information which is then passed to the home network using information contained in the message packet header and which allows the SMSC to identify the home network.

If however the subscriber is using a prepaid subscription facility, the home network operator may under these circumstances be unable to recover the cost from the subscriber, if for example the subscriber has insufficient credit remaining.

It is therefore known for mobile terminals intended for use in a prepaid subscription service to be provided with facilities for making outgoing SMS services which are only operable when the mobile terminal is registered with the home network for telecommunications traffic. The making of outgoing SMS messages is therefore barred whenever the mobile terminal is “roaming”, i.e. registered with a different network. From the point of view of the home network, this allows the home network operator to prevent the occurrence of SMS messages which cannot be billed to subscribers with prepaid subscription accounts. A disadvantage of this arrangement from the point of view of the subscriber is that, when travelling abroad, it will not generally be possible to register with the home network due to the limited geographical extent of networks so that the making of SMS outgoing massages will not be an available facility for a prepaid subscription user.

A similar problem exists in the context of WAP enabled telephones in which outgoing messages, such as a URL request, include the address of a gateway via which access to the internet is obtained. The home network operator may have a specific preference for which gateway is to be utilized for the making of such data calls and there therefore remains a need to provide an improved method and apparatus for controlling the selection of gateway address.

More generally, data messages in a mobile telecommunications system may be routed via a routing center selected from a plurality of available routing centers. The present invention has application therefore more generally to the selection of an address for a routing center to be included in a message data field originating in the mobile terminal.

According to the present invention, a method and apparatus are provided whereby better control is provided in the manner in which outgoing messages are addressed.

### BRIEF DESCRIPTION OF THE DRAWINGS

Preferred embodiments of the present invention will now be described by way of example only and with reference to the accompanying drawings of which:

FIG. 1 is a schematic diagram of mobile telephone operation;

FIG. 2 is a schematic diagram of the internal structure of a mobile telephone fitted with a SIM card;

FIG. 3 is a schematic diagram of the structure of a SIM card;

FIG. 4 is a schematic diagram of the applications contained in a SIM card;

FIG. 5 is a schematic diagram of the contents of a SMS message;

FIG. 6 is a flow chart illustrating the manner in which a mobile terminal functions during a first stage of generating an outgoing SMS message;

FIG. 7 is a flowchart illustrating the corresponding function of the SIM card;

FIG. 8 is a flowchart illustrating a second stage performed by the mobile terminal when generating an outgoing SMS message;

FIG. 9 is a schematic diagram illustrating the manner in which programs may be transmitted and stored for use in the embodiments;

FIG. 10 is a schematic diagram of a WAP mobile telephone in use to generate an outgoing message; and

FIG. 11 is a schematic diagram of a WAP message.

### DESCRIPTION OF THE PREFERRED EMBODIMENTS

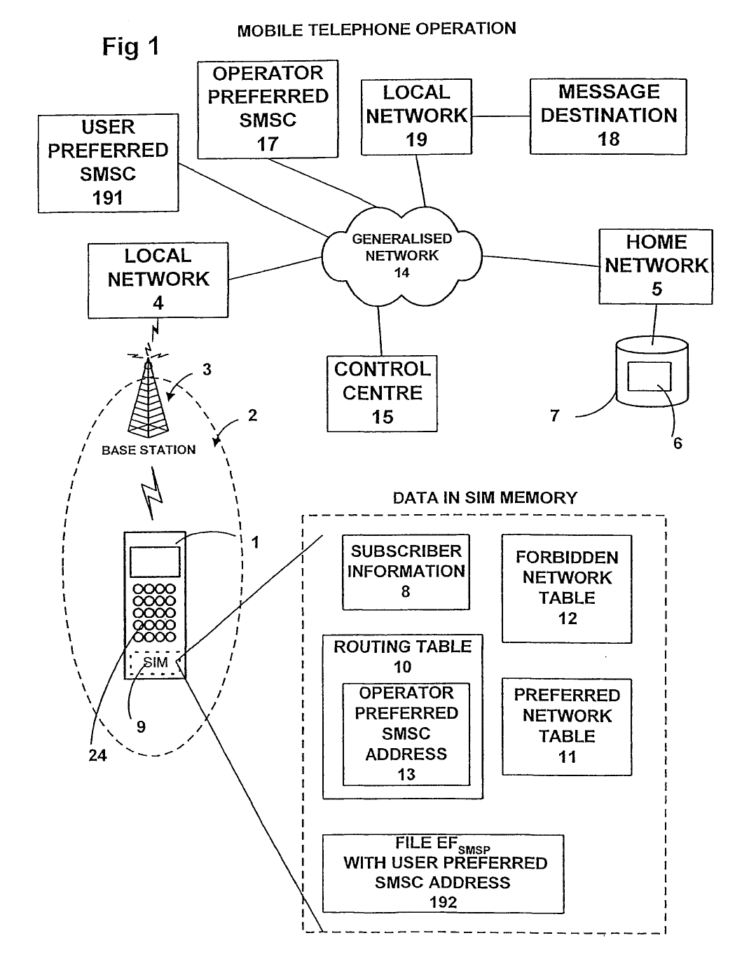

FIG. 1 illustrates schematically a mobile telephone 1 operating in a GSM cellular telecommunications system in which communication over an air interface 2 is established between the telephone and a base station 3.

The mobile telephone 1 is illustrated as being registered with a local network 4 which is accessible via a number of such base stations 3 providing coverage geographically in a cellular configuration and which communicates with other mobile and landline networks, illustrated in FIG. 1 by generalized network 14, for telecommunications traffic including the routing of message packets containing SMS messages as well as voice and other data communications.

A home network 5 has subscriber records 6 stored in a database 7 and administers a prepaid subscription account with a user of the mobile telephone 1, the mobile telephone being uniquely identified by subscriber information 8 which is stored in a SIM card 9 within the mobile telephone. The registration of the mobile telephone 1 with the local network 4 rather than the home network 5 may be by user choice or by necessity, for example when geographical location demands, and such registration with networks other than the home network is referred to as “roaming”.

The SIM card 9 also stores as a data file a routing table 10 enabling the mobile telephone 1 to automatically route voice and data communications via a least cost route within the generalized network 14 in accordance with data contained in the routing table, and the SIM card also includes a preferred network table 11 and forbidden network table 12 used in regulating the manner in which local network selection is carried out for registration purposes under circumstances where more than one network is available for registration. One of the fields of the routing table 10 is dedicated to an operator preferred SMSC address 13 for routing SMS messages to the operator preferred SMSC 17. Write-access by the user to write data to the memory file storing the operator preferred SMSC address 13 is prohibited.

The SIM card also stores a data file 192 referred to as Elementary File EF_{SMSP} accessible to the user and containing a user preferred SMSC address for use in controlling the routing of outgoing SMS messages in accordance with the preference of the subscriber. The user preferred SMSC address is a telephone number of a user preferred SMSC 191, i.e. the SMSC which the user or subscriber would prefer to route the SMS message to the destination 18.

A control center 15 accessible for communication via the generalized network 14 is responsible for preparing the routing tables 10 for downloading to mobile terminals including the mobile telephone 1, the downloading of new tables being effected by SMS messages broadcast over the air interface 2.

Also shown in FIG. 1 is an operator preferred SMSC 17 which is the SMSC preferred by the operator of the home network 5 for forwarding SMS message originating from the mobile telephone 1 to a message destination 18. The operator preferred SMSC 17 is in this example an independent SMSC which has been designated by the home network 5 to carry all SMS message traffic originating from subscribers of the home network operator. The home network 5 therefore has in place agreed protocols for billing information to be communicated between the operator preferred SMSC 17 and home network 5 for the billing of SMS messages. In the example of FIG. 1, the message destination 18 is accessed via a further local network 19, as for example in the case where the message destination 18 is a further mobile telephone which is presently registered with the further local network 19.

The SIM card 9 of the mobile telephone 1 is configured to enable the home network operator 5 to override user preference and control the addressing of SMS messages such that the operator preferred SMSC 17 is utilized when sending SMS messages. The sequence of events in sending a typical message is initiated by the user turning on the mobile telephone 1, followed by a registration procedure in which the mobile telephone registers with local network 4. As a precursor to this registration procedure, the mobile telephone 1 performs a scanning operation to determine the available networks for registration and consults the preferred network table 11 and forbidden network table 12 stored in the SIM card 9 before making the final selection.

The local network 4 during registration will establish communication with the home network 5 identified by data in the SIM card 9 in order to confirm subscriber information 8 obtained from the SIM card and the billing status as indicated by the subscriber records 6.

The user of the mobile telephone 1 prepares the subject matter to be sent in an SMS message, typically comprising text entered using a keypad 24 of the mobile telephone. The user then enters the digits identifying the address of the message destination 18 which typically will be a telephone number entered in the keypad 24 or accessed from a memory. Optionally, the user may additionally enter the address of the user preferred SMSC 191, this user preferred SMSC address 192 being written into the file EF_{SMSP}. Alternatively, if the user does not enter any SMSC address, the value of the address stored in the file EF_{SMSP} remains unaltered and is equal either to a previously entered value or a default value determined when the SIM card is initialized. For the purpose of an initial example, it will be assumed that the user has entered an address which corresponds to the operator preferred SMSC 17 so that in FIG. 1 the user preferred SMSC 191 and operator preferred SMSC 17 are one and the same. The user then activates a “send” button of the mobile telephone 1 to initiate the message sending process.

A message packet is output from the mobile telephone 1 which includes the address of the operator preferred SMSC 17. The message is therefore routed via the local network 4 and the generalized network 14 to the preferred SMSC 17.

The preferred SMSC 17 performs a store and forward function such that a determination is made as to whether the message destination 18 is able to receive the SMS message. When the message destination 18 is available, the SMS message is forwarded via the generalized network 14 and local network 19 to be received by the message destination 18.

Billing information for the SMS message is passed from the SMSC 17 to the home network 5 and the subscriber records 6 are updated to record the remaining credit.

In a second example, the user enters an SMSC address corresponding to a user preferred SMSC 191 which is different from the operator preferred SMSC 17. (Alternatively, the existing stored value of address in EF_{SMSP} is used without user intervention and the address is different from the operator preferred address.) In this instance, as described in greater detail below, the outgoing SMS message is trapped and the SMSC address contained in the message header is modified to correspond to the operator preferred SMSC address 13. The routing of the SMS message thereafter follows the above described route via the operator preferred SMSC 17, even though the user has expressly entered a different address (or the existing EF_{SMSP} defines a different address).

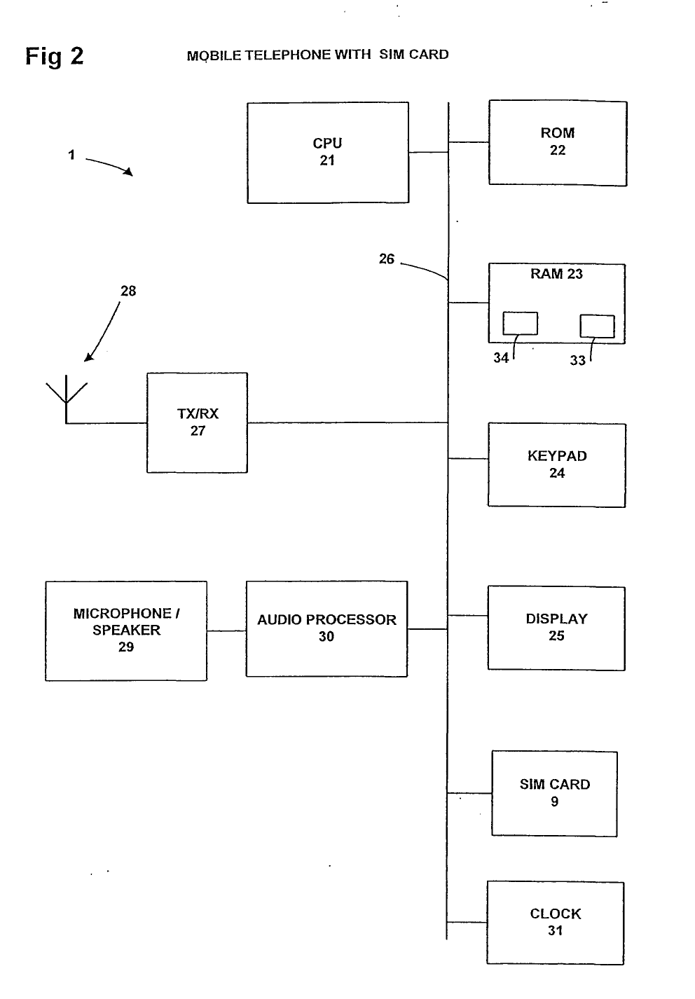

The structure of the mobile telephone 1 is illustrated in FIG. 2 and includes an internal processor 21 which communicates with the processor of SIM card 9 via a databus 26. Also connected to the processor 21 by databus 26 are Read Only Memory (ROM) 22, Random Access Memory (RAM) 23, a keypad 24, display 25, and internal clock 31. An audio processor 30 and microphone/speaker unit 29 are also provided together with transmit and receive circuits 27 which are connected to antenna 28. The RAM 23 stores operating data and applications for the mobile telephone 1 including a message file 34 for storing an outgoing SMS message and a message handling program 33 which is used in generating outgoing SMS messages.

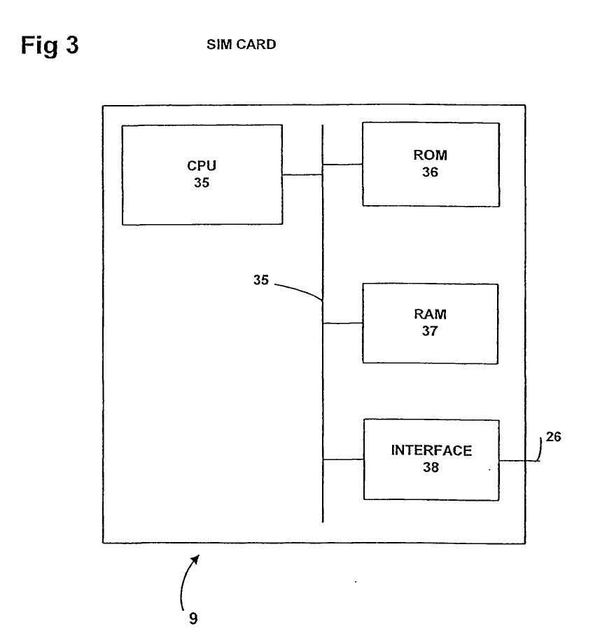

The internal structure of the SIM card 9 is illustrated schematically in FIG. 3 and comprises SIM card processor 35, ROM 36, RAM 37 and an interface 38 for communication with the databus 26. The SIM card 9 is a portable integrated circuit device which is removably inserted into the mobile telephone 1.

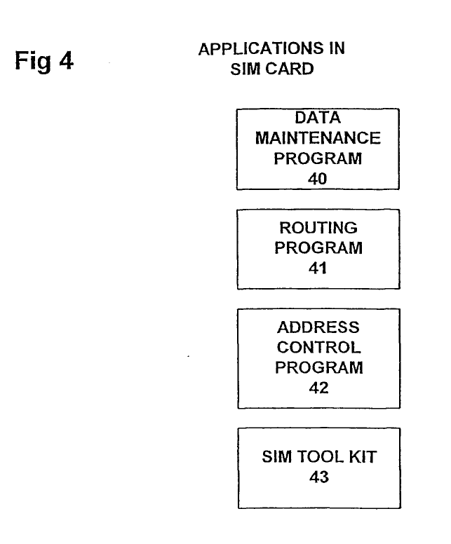

FIG. 4 illustrates schematically the applications stored in the RAM 36 of the SIM card 9, including a data maintenance program 40, a routing program 41, SMSC address control program 42 and SIM Toolkit 43.

It is implicit in the above description that the mobile telephone 1 has software making the mobile telephone compliant with the SIM Toolkit facility under the GSM standards definition, the SIM Toolkit 43 being stored in the SIM card 9 and enabling the SIM card to alter the services provided by the mobile telephone and to act as a controlling interface between the mobile telephone and the air interface 2.

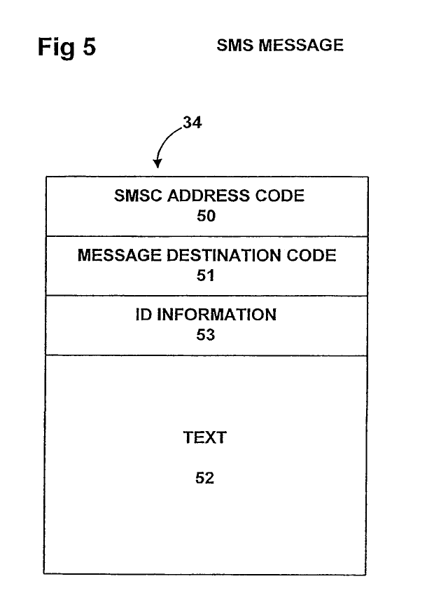

FIG. 5 illustrates schematically the contents of the SMS message 49 constructed by the processor 21 of the mobile telephone 1, the message being stored as message file 34 comprising a first data field 50 containing SMSC address code, a second data field 51 containing message destination address code, a third field 53 containing ID information and a fourth field 52 containing text. The SMSC address code in field 50 is initially set to be identical to the code defined by the user preferred SMSC address read from the elementary file 192.

The message destination code in field 51 is obtained from the user input telephone number entered using the keypad 24. The ID information in field 53 is entered using subscriber information 8 read from the memory of the SIM card 9. The text in field 52 is generally entered manually using the keypad 24.

The message file 34 containing data fields 50, 51, 52 and 53 is stored temporarily in RAM 23 and, when the “send” signal is received by the user actuating keypad 24, the processor 21 prepares to send the SMS message.

However, the message handing program operated by the processor 21 is configured by the SIM toolkit 43 to trap any outgoing messages and send a notification to the SIM card processor 35 including details of the SMSC address code in field 50 and message destination code in field 51. The notification takes the form of an ENVELOPE command as defined in the GSM standard.

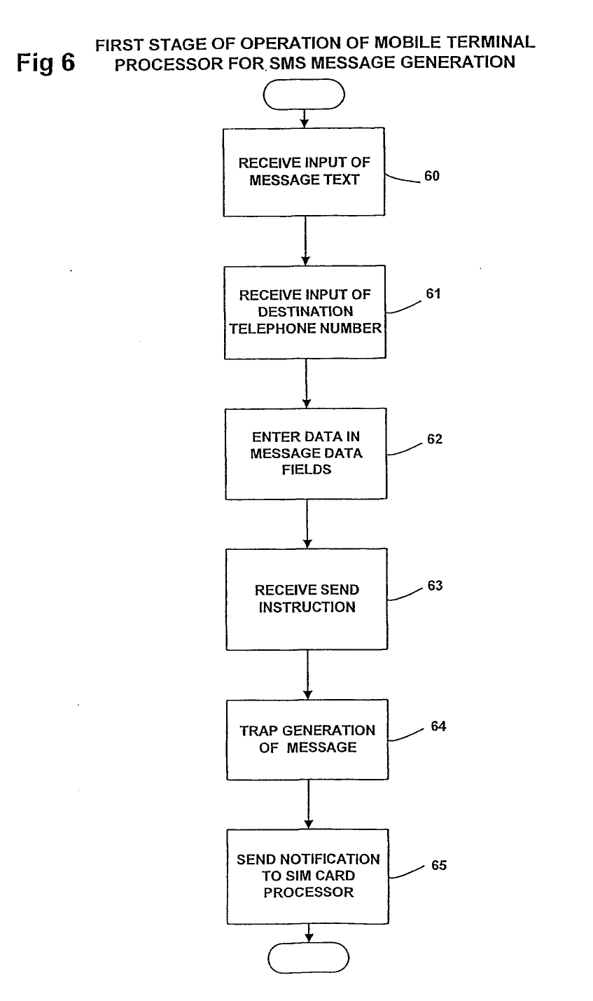

This procedure is illustrated in FIG. 6 where at, step 60, the processor 21 receives the input of message text and at step 61 receives the input of a message destination address, i.e. the telephone number of the intended destination for the message.

At step 62, the processor 21 enters data in fields 50 to 53 of the message file as illustrated in FIG. 5. At step 63, the send instruction is received and at step 64 the generation of the SMS message is trapped. At step 65, the notification is sent to the SIM card processor 35.

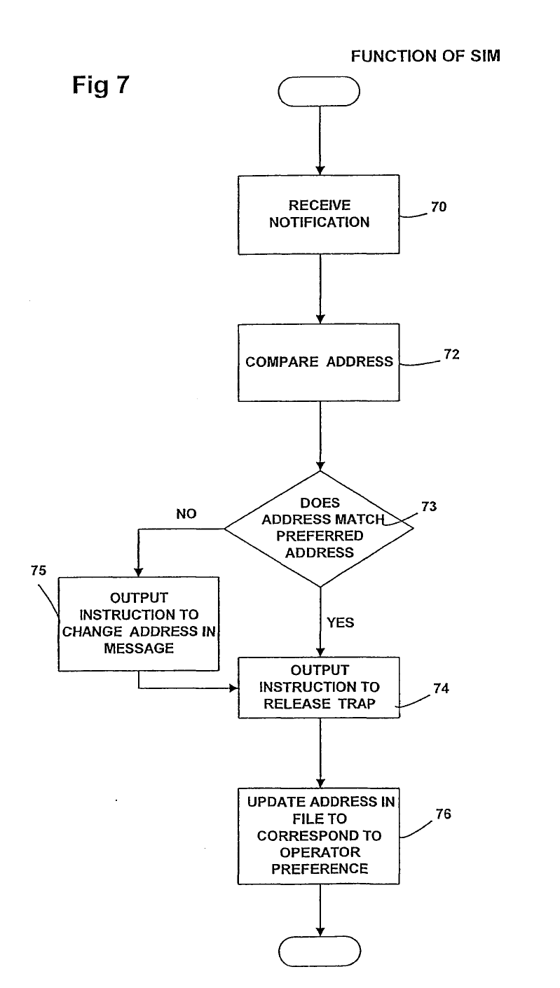

The function of the SIM card processor 35 in response to the notification from step 65 is illustrated in FIG. 7. At step 70, the notification is received and at step 72 the SMSC address code in field 50 is compared with the operator preferred SMSC address 13 which is stored in RAM 37 of the SIM card. If the comparison step 73 determines that the addresses match, the SIM card processor 35 at step 74 outputs an instruction via the interface 38 for the internal processor 21 to release the SMS message. The SMS message is then output for routing to the SMSC address defined by the SMSC address code in field 50.

If however the comparison step 73 determines that the addresses do not match, the SIM card processor 35 outputs an instruction to the internal processor 21 to change the SMS address code stored in the message file 34 in field 50 to be that of the stored value of the operator preferred SMSC address 13.

The SIM card processor 35 then outputs at step 74 the instruction to release the SMS message which then is output to the SMSC address defined by the SMSC address code in field 50.

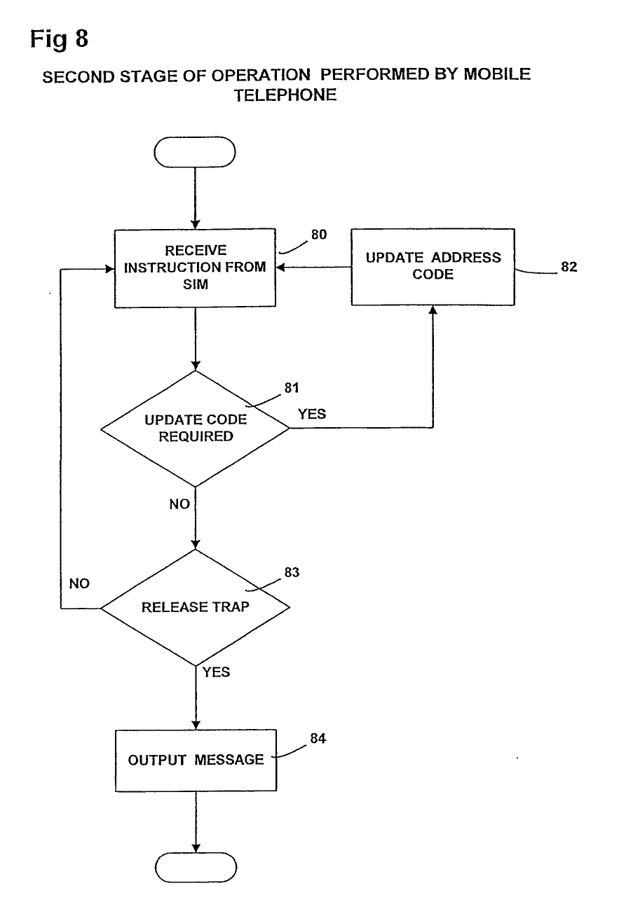

The second stage performed by the mobile telephone 1 is illustrated in FIG. 8 where at step 80 an instruction is received from the SIM card 9, the instruction being generated either by step 74 or step 75 in FIG. 7.

At step 81, the processor 21 determines whether the instruction is an instruction to update the SMSC address code in field 50 and, if so, the SMSC address code stored in field 50 of the message file 34 is updated at step 82. At this stage, the SMS message formatted as shown in FIG. 5 is stored in the RAM 23 in message file 34 illustrated schematically in FIG. 2 and includes SMSC address code corresponding to the operator preferred SMSC address 13 as stored in the SIM card 9.

The processor 21 awaits receipt of a further instruction from the SIM card 9 and, when a further instruction is received which is determined at step 83 to be an instruction to release the trapped message, the processor 21 initiates the outputting of the SMS message at step 84.

The SMS message is then processed and transmitted by the transmit circuit 27 to be received by base station 3. The message is routed to the preferred SMSC 17 via the local network 4 and generalized network 14. The operator preferred SMSC 17 performs its store and forward facility and ultimately routes the message via local network 19 to the message destination 18. Billing information is communicated to the home network 5.

The preferred SMSC address 13 stored in the SIM card 9 may be configured by the control center 15. This may for example in response to a request by the operators of the home network 5.

To reconfigure the stored preferred SMSC address 13, the control center 15 forwards a message to the mobile telephone 1 via the local network 4 where the processor 21 passes the contents of the message to the SIM card 9 for processing by the data maintenance program 40 operated by the processor 35.

The data maintenance program 40 determines whether the received message contains an instruction to reconfigure the operator preferred SMSC address 13 and if so causes the stored address to be overwritten by the newly received address.

In a preferred embodiment, the mobile telephone 1 utilizes the stored routing table 10 to automatically optimize the routing of outgoing voice calls. This is achieved in the manner described for example in GB-A-2328117 where the routing table 10 is described as acting as a lookup table for determine prefix codes added to a dialed number. In this way, least cost routing is achieved for voice traffic originating from the mobile telephone 1.

The routing table 10 is periodically refreshed by a wireless broadcast originating from the control center 15 and typically comprising one or more SMS messages.

The control center 15 may therefore configure the messages containing the updated routing table information to additionally include information defining an updated preferred SMSC address 13.

On receiving such an updating message, the processor 35 of the SIM card 9 operates the data maintenance program 40 to update the stored routing table 10 including the operator preferred SMSC address 13. Subsequent routing of voice messages is controlled using the routing program 41 and the updated preferred SMSC address 13 is utilized by the SMSC address control program 42.

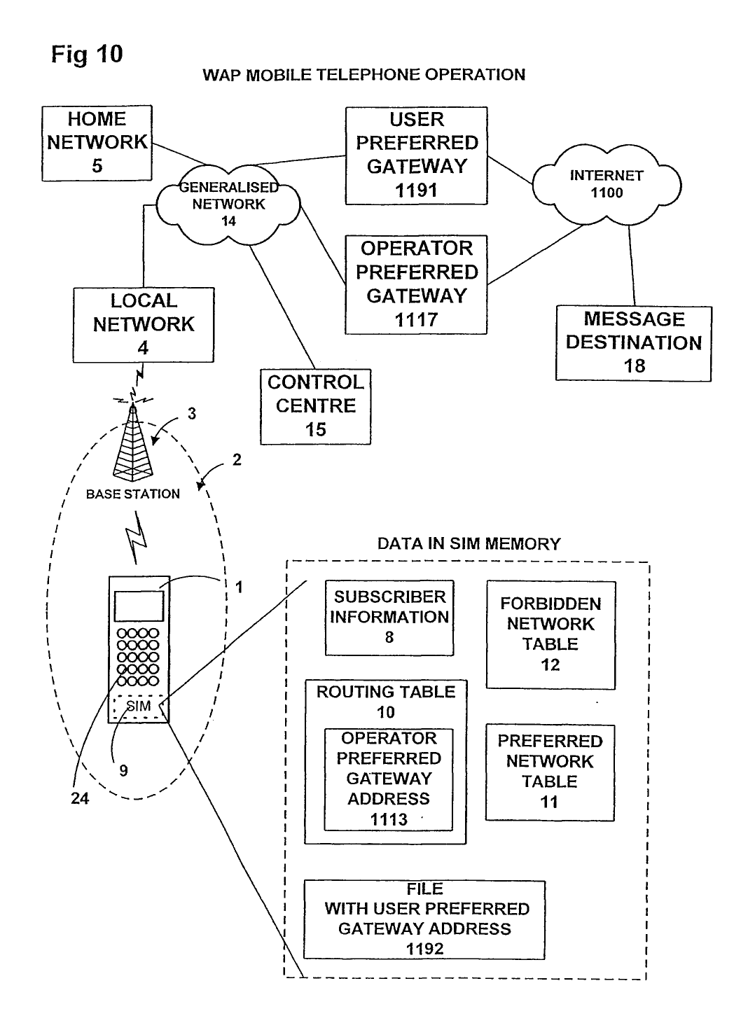

A second embodiment is illustrated in FIG. 10 in which a WAP enabled mobile telephone is illustrated as being used to send a URL (Universal Resource Locator) request via the Internet 1100 to a message destination 18 which in this instance is a web server which responds by returning a data message to the telephone in the form of code defining a web page.

The data message generated by the WAP enabled telephone 1 may be routed by any one of a number of gateways such as those represented in FIG. 10 by user preferred gateway 1191 and operator preferred gateway 1117, each of these gateways acting as an Internet service provider, thereby providing an interface between generalized telecommunications network 14 which is accessed by mobile networks and the Internet 1100.

The data held in the SIM card memory 37 includes an operator preferred gateway address 1113 which is the telephone number of the operator preferred gateway 1117. The data in the SIM card memory 37 also includes a file 1192 containing the user preferred gateway address, i.e. the telephone number of the user preferred gateway 1191. In practice, the user preferred gateway address 1192 may be any address preconfigured into the SIM card memory and need not necessarily have been entered by the user. For ease of description however, the gateway address 1192 and the gateway 1191 are referred as being “user preferred” and this is correct to the extent that they refer to a gateway which is other than the operator preferred gateway 1117.

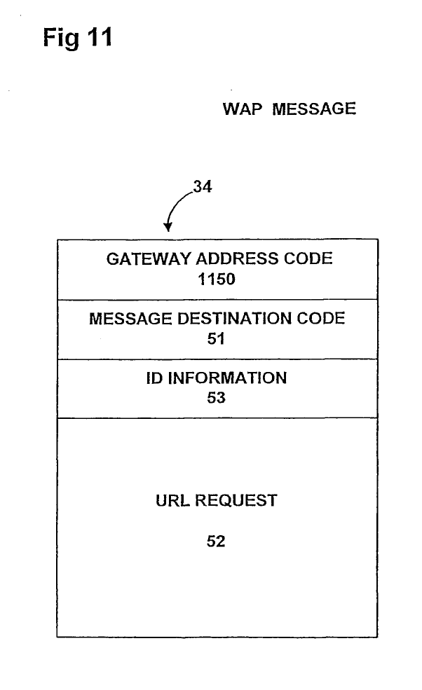

FIG. 11 shows the structure of a message generated by the WAP enabled mobile telephone 1, the message comprising a gateway address code inserted in a first data field 1150, a message destination code inserted in a second data field 51, and ID information inserted in a third data field 53. The content of the message in the form of a URL request is contained in a fourth data field 52.

The method of operating the mobile telephone 1 in the embodiment of FIG. 10 follows generally the above described method set out in the flowcharts of FIGS. 6, 7 and 8 to the extent that the initially prepared outgoing message is first trapped at step 64 and a notification sent at step 65 to the SIM card processor 35. This notification is forwarded to the SIM card 9 using the Mobile Originated Short Message control by SIM facility and uses an Envelope command to transfer the data from the internal processor 21 of the telephone 1 to the SIM card processor 35.

At step 72, the gateway address code in the data field 1150 is compared with the operator preferred gateway address 1113 stored in a file in SIM card memory 37 and, if at step 73 it is determined that the addresses match, the SIM card 9 outputs an instruction to the internal processor 21 to release the trap, following which at the message is output.

At step 76, the SIM card processor 35 updates the file 1192 to include the operator preferred gateway address in preference to the previously stored address.

According to the method of second embodiment, the home network 5 is able to ensure that the operator preferred gateway 1117 is always utilized. It is thereby able to override any user entered gateway address and to correct a situation where the currently stored operator preferred gateway address is superseded by a new requirement of the operator. This may arise for example when a gateway address is included in the configuration of the SIM card when the telephone is initially purchased and at some time later the operator designates a new preferred gateway. The new gateway address can be downloaded to the SIM card 9 for example as part of routing table 10 in a wireless broadcast. Any subsequent use of the mobile telephone 1 to generate an outgoing message will automatically have the gateway address corrected and the file 1192 updated to include the correct gateway address.

Various alternative embodiments are contemplated as falling within the scope of the appended claims. The above described embodiments may for example omit the use of a routing table 10 and routing program 41. The operator preferred gateway address 1113 of the second embodiment and the operator SMSC address 13 of the first embodiment may therefore exist as separate files contained in SIM card memory and may be updated by downloading updating data contained in wireless broadcasts. A suitable form of broadcast is an SMS message although other forms of broadcast and other forms of protocol may be utilized where appropriate.

The first embodiment is described as using a specific elementary file 192 for the storage of the address of the SMSC. Alternative embodiments are proposed in which different files are used for the storage of this address.

Reference is made to entering the user generated message using the keypad 24 of the mobile telephone 1. The text or other information may be input by other means such as by communication with a peripheral or accessory device to the mobile telephone 1. More generally, alternative embodiments utilize mobile terminals which are not mobile telephones per se and may be any one of a number of new generation devices capable of connection to mobile telecommunications systems such as the GSM system. Not all of these devices are capable of voice message transmission, some devices being totally dedicated to data transmission in the form of text or images. Personal Digital Assistants are an example of apparatus which may function as a mobile terminal as an embodiment of the present invention. The above description should therefore be understood to apply equally to mobile terminals whenever reference is made in the specific examples to a mobile telephone.

In the preferred embodiments, reference is made to the GSM system. Other systems and protocols whether existing or proposed for future implementation may similarly have a need for the message address to be checked and if necessary replaced in the manner described above in the GSM system. Further embodiments are therefore envisaged in which mobile terminals operating in such systems and protocols perform the above described method steps for messages, including by way of example short messages and URL request messages via the internet. Additional embodiments are envisaged in which mobile terminals do not include a SIM card and all of the method steps of comparing and replacing addresses are performed by a single processor. The method performed in such embodiments corresponds generally to the method flowcharts of FIGS. 6, 7 and 8 with the exception that there is no need for the transfer of instructions between internal processor 21 and SIM card processor 35.

Further embodiments are also envisaged in which the location in memory of files such as the operator preferred address file is other than as shown in FIGS. 1 and 10. The memory of the mobile terminal such as RAM 23 in FIG. 2 may be utilized for storage of one or more of the address files, routing table file and other files as may be convenient.

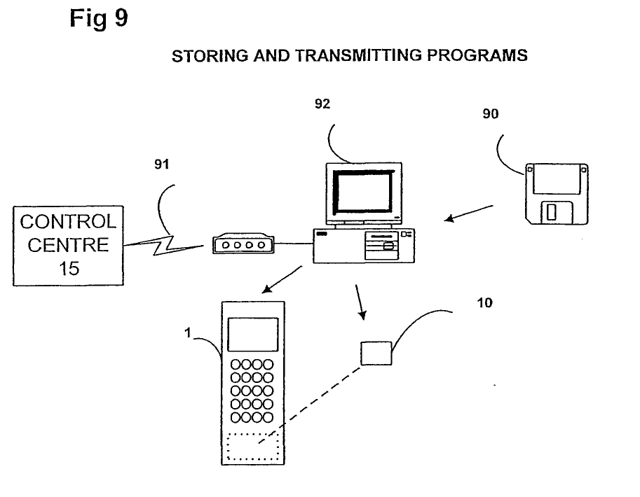

The programs used in the SIM card 9 and internal processor 21 of the mobile terminal 1 may be installed using a personal computer 92, the programs being initially stored on a portable storage medium such as a floppy disk 90, as illustrated in FIG. 9 Alternatively, the personal computer 92 may obtain the programs as signals 91 communicated over a network such as the Internet 1100 from control center 15. Further aspects of the present invention therefore include the above-mentioned programs, a storage medium containing such programs and signals representative of the programs, wherein the programs define the steps of the above described methods.

In the above described embodiments, reference is made to an operator preferred SMSC address. The operator in this context may be a network operator of the telecommunications system or another administrator, such as a virtual network operator having a leasing arrangement with a network operator for use of a network. References to an operator preferred SMSC should therefore be understood where appropriate to include more generally an administrator preferred SMSC address and actions to update the address should correspondingly be understood to be initiated by the administrator.

1. A method of operating a mobile terminal in a mobile telecommunications system in which data messages are routed to a destination having a destination address via a routing center selected from a plurality of available routing centers,
the method comprising:
receiving user generated data defining data content of an outgoing message;
generating a message including a first data field containing a first routing center address defining a network address of a first routing center, a second data field containing the destination address, and a third data field containing the user generated data;
receiving an instruction to send the message;
trapping the outgoing message;
actuating a processor to compare the first routing center address with a second routing center address stored in a memory to which the user does not have write-access and wherein the second routing center address is determined by an administrator of the telecommunications system, and, if the addresses are different, replacing the first routing center address by the second routing center address in the data field; and
releasing the outgoing message for being routed via a second routing center identified by the second routing center address.

2. The method as claimed in claim 1, wherein,
the first routing center address is stored in a first memory file to which the user has write-access, and
generating the message comprises transferring the first routing center address from the first memory file to the first data field of the message.

3. The method as claimed in claim 2, wherein the first memory file is located in a SIM card.

4. The method as claimed in claim 2, further comprising:
a step updating the first memory file to contain the second routing center address.

5. The method as claimed in claim 1, wherein the generating comprises receiving the first routing center address from an input of user generated data.

6. The method as claimed in claim 1, wherein,
the memory in which the second routing center address is stored is a second memory file of a SIM card of the mobile terminal, and
the processor performing the comparing, replacing and releasing is constituted by a processor of the SIM card.

7. The method as claimed in claim 1, further comprising:
updating the second routing center address stored in the memory in response to the mobile terminal receiving a broadcast wireless updating message containing an updated routing center address.

8. The method as claimed in claim 7, wherein the updating message is contained in an SMS message received by the mobile terminal.

9. The method as claimed in claim 7, wherein the updating message also contains data for updating a routing table for use in routing of voice calls made by the mobile terminal.

10. The method as claimed in claim 9, wherein the updating message originates from a control center for preparing and broadcasting the routing table data.

11. The method as claimed in claim 1, wherein the second routing center is other than a message handling platform of a home network with which the mobile terminal is subscription registered.

12. The method as claimed in claim 1, wherein generating the message comprises including a fourth field comprising subscriber information identifying a prepaid subscription account.

13. The method as claimed in claim 1, wherein the routing centers are short message service centers.

14. The method as claimed in claim 13, wherein,
the message is an SMS message, and
the mobile telecommunication system is a GSM system.

15. The method as claimed in claim 1, wherein the routing centers are gateways to the Internet.

16. The method as claimed in claim 15, wherein,
the mobile terminal is WAP enabled, and
the message is a URL request.

17. A mobile terminal for use in a mobile telecommunications system in which data messages are routed to a destination having a destination address via a routing center selected from a plurality of available routing centers,
the terminal comprising:
an input for receiving user generated data defining data content of an outgoing message;
a generator for generating a message including a first data field containing a first routing center address defining a network address of a first routing center, a second data field containing the destination address, and a third data field containing the user generated data;
an instruction receiver for receiving an instruction to send the message;
a trap for trapping the outgoing message;
a processor operable to compare the first routing center address with a second routing center address stored in a memory to which the user does not have write-access and wherein the second routing center address is determined by an administrator of the telecommunications system, and, if the addresses are different, to replace the first routing center address by the second routing center address in the data field; and
a releaser for releasing the outgoing message for being routed via a second routing center identified by the second routing center address.

18. The terminal as claimed in claim 17 wherein,
the first routing center address is stored in a first memory file of the mobile terminal, and
the generator is operable to transfer the first routing center address from the first memory file to the first data field of the message.

19. The terminal as claimed in claim 18, wherein the first memory file is located in a SIM card memory.

20. The terminal as claimed in claim 18, further comprising:
an updater for updating the first memory file to contain the second routing center address.

21. The terminal as claimed in claim 17, wherein the generator comprises a receiver for receiving the first routing center address from an input means for the input of user generated data.

22. The terminal as claimed in claim 21, wherein the input comprises a keypad of the terminal.

23. The terminal as claimed in claim 21, wherein the input comprises an interface for connection in use to an external data input device.

24. The A terminal as claimed in claim 18, wherein,
the memory in which the second routing center address is stored is a second memory file of a SIM card of the mobile terminal, and
the processor operable to compare, replace and release is constituted by a processor of the SIM card.

25. The terminal as claimed in claim 17, further comprising:
an updater for updating the second routing center address stored in the memory in response to the mobile terminal receiving a broadcast wireless updating message containing an updated routing center address.

26. The terminal as claimed in claim 25, further comprising:
an extractor for extracting the updated routing center address from an SMS message received by the mobile terminal.

27. The terminal as claimed in claim 25, wherein,
the updating message contains data for updating a routing table for use in routing of voice calls made by the mobile terminal, and further comprising:
an extractor for extracting the updated routing center address from the updating message.

28. The terminal as claimed in claim 18, wherein the SIM card contains subscriber information identifying a prepaid subscription account.

29. A method of operating a mobile terminal in a GSM telecommunications system in which SMS messages are routed to a destination address via a SMS center selected from a plurality of available SMS centers for providing a store and forward facility,
the method comprising:
receiving user generated data defining data content of an outgoing SMS message;
generating an SMS message including a first data field containing a first SMS center address defining a network address of a first SMS center, a second data field containing the destination address and a third field containing the user generated data;
receiving an instruction to send the message;
trapping the outgoing SMS message;
operating a SIM card processor to compare the first SMS center address with a second SMS center address stored in a data file of the SIM card to which the user does not have write-access and wherein the second routing center address is determined by an administrator of the telecommunications system, and, if the addresses are different, replacing the first SMS center address by the second SMS center address in the data field; and
releasing the outgoing SMS message for being routed via a second SMS center identified by the second SMS center address.

30. A mobile terminal for use in a GSM telecommunications system in which SMS messages are routed to a destination address via a SMS center selected from a plurality of available SMS centers for providing a store and forward facility,
the terminal comprising:
receiving means for receiving user generated data defining data content of an outgoing SMS message;
generating means for generating an SMS message including a first data field containing a first SMS center address defining a network address of a first SMS center, a second data field containing the destination address and a third field containing the user generated data;
means for receiving an instruction to send the message;
means for trapping the outgoing SMS message;
a SIM card processor operable to compare the first SMS center address with a second SMS center address stored in a memory file of the SIM card to which the user does not have write-access and wherein the second routing center address is determined by an administrator of the telecommunications system, and, if the addresses are different, to replace the first SMS center address by the second SMS center address in the data field; and
means for releasing the outgoing SMS message for being routed via a second SMS center identified by the second SMS center address.

31. A method of operating a WAP enabled mobile terminal in a GSM telecommunications system in which messages are routed to a destination address via an internet gateway selected from a plurality of available gateways,
the method comprising:
receiving user generated data defining data content of an outgoing message;
generating a message including a data field containing a first gateway address defining a network address of a first gateway, a second data field containing the destination address and a third field containing the user generated data;
receiving an instruction to send the message;
trapping the outgoing message;
operating a SIM card processor to compare the first gateway address with a second gateway address stored in a memory file of the SIM card to which the user does not have write-access and wherein the second gateway address is determined by an administrator of the telecommunications system, and, if the addresses are different, replacing the first gateway address by the second gateway address in the data field; and
releasing the outgoing message for being routed via a second gateway identified by the second gateway address.

32. A WAP enabled mobile terminal for use in a GSM telecommunications system in which messages are routed to a destination address via an interne gateway selected from a plurality of available gateways,
the terminal comprising:
receiving means for receiving user generated data defining data content of an outgoing message;
generating means for generating a message including a first data field containing a first gateway address defining a network address of a first gateway, a second data field containing the destination address and a third field containing the user generated data;
means for receiving an instruction to send the message;
means for trapping the outgoing message;
a SIM card processor operable to compare the first gateway address with a second gateway address stored in a memory file of the SIM card to which the user does not have write-access and wherein the second gateway address is determined by an administrator of the telecommunications system, and, if the addresses are different, and to replace the first gateway address by the second gateway address in the data field; and
means for releasing the outgoing message for being routed via a second gateway identified by the second gateway address.

33. A telecommunications system comprising a network for routing data messages from a mobile terminal to a destination having destination address via a routing center selected from a plurality of available routing centers,
the terminal comprising:
input means for receiving user generated data defining data content of an outgoing message;
generating means for generating a message including a first data field containing a first routing center address defining a network address of a first routing center, a second data field containing the destination address, and a third data field containing the user generated data;
instruction receiving means for receiving an instruction to send the message;
trap means for trapping the outgoing message;
a processor operable to compare the first routing center address with a second routing center address stored in a memory to which the user does not have write-access and wherein the second routing center address is determined by an administrator of the telecommunications system, and, if the addresses are different, to replace the first routing center address by the second routing center address in the data field; and
means for releasing the outgoing message for being routed via a second routing center identified by the second routing center address;
and the system further comprising a control center operable to broadcast a wireless updating message containing an updated routing center address, and wherein the terminal is operable to receive the updating message and to replace the second routing center address stored in the memory with an updated routing center address contained in the updating message.

34. A computer readable non-transitory storage medium storing processor implementable instructions for controlling a processor to carry out all of the functions performed by the processor in the method of claim 1.
